(19) United States
(12) Patent Application Publication
(10) Pub. No.: US 2009/0316380 A1
(43) Pub. Date: Dec. 24, 2009

(54) Stress-Limiting Device For Forced-Based Input Panels

(76) Inventor: Stephen G. Armstrong, Pleasant View, UT (US)

Correspondence Address: THORPE NORTH & WESTERN, LLP., P.O. Box 1219, SANDY, UT, 84091-1219, US

(21) Appl. No.: 12/469,052

(22) Filed: May 20, 2009

Related U.S. Application Data
(60) Provisional application No. 61/128,333, filed on May 20, 2008.

(51) Int. Cl. H02B 1/01; G06F 3/041

(52) U.S. Cl. 361/829; 345/173

(57) ABSTRACT

A system for preventing damage caused by the application of excessive force to a force-based input device having an input panel supported by a plurality of deflecting beam segments, in which the excessive force could cause permanent plastic deformation in the beam segments. The system includes a stress-limiting device operable about the deflecting beam segments to control the motion of the beam segments to within a pre-determined range.

### RELATED APPLICATIONS

This application claims the benefit of U.S. Provisional Application Ser. No. 61/128,333, filed May 20, 2008, and entitled, “Stress Limiting Device for Force-Based Input Panels,” which is incorporated by reference herein in its entirety.

### FIELD OF THE INVENTION

The field of the invention relates generally to forced-based input panels, and more specifically to forced-based input panels that are supported by flexible beam segments.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, automatic teller machines, point of sale terminals, vending machines, medical devices, keypads, keyboards, and others.

Currently, there are a variety of different types of input devices available on the market. Some examples include resistive-based input devices, capacitance-based input devices, surface acoustic wave-based devices, infrared-based devices, force-based input devices, and others. While providing some useful functional aspects, each of these prior related types of input devices can suffer shortcomings in one or more areas.

Resistive-based input devices typically comprise two conductive plates that are required to be pressed together until contact is made between them. Resistive sensors only allow transmission of about 75% of the light from the input pad, thereby preventing their application in detailed graphic applications.

Capacitance-based input devices operate by measuring the capacitance of the object applying the force to ground, or by measuring the alteration of the transcapacitance between different sensors. Although inexpensive to manufacture, capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Infrared-based devices are operated by infrared radiation emitted about the surface of the input pad of the device. However, these are sensitive to debris, such as dirt, that affect their accuracy.

Force-based input devices are configured to measure the location and magnitude of the forces applied to and transmitted by the input pad. Force-based input devices provide some advantages over the other types of input devices. For instance, they are typically very rugged and durable, meaning they are not easily damaged from drops or impact collisions. Indeed, the input pad (e.g., touch screen) can be a thick piece of transparent material, resistant to breakage, scratching and so forth. There are no interposed layers in the input pad that absorb, diffuse or reflect light, thus 100% of available input pad light can be transmitted. Furthermore, they are typically impervious to the accumulation of dirt, dust, oil, moisture or other foreign debris on the input pad.

Force-based input devices generally comprise one or more force sensors that are configured to measure the applied force. The force sensors can be operated with gloved fingers, bare fingers, styli, pens pencils or any object that can apply a force to the input pad. Despite their advantages, force-based input devices can be too large and bulky to be used effectively in many touch screen applications. Additionally, conventional force-based input devices, as well as most other types of input devices, are capable of registering touch from only one direction, or in other words, on one side of the input pad, thereby limiting the force-based input device to monitor or screen-type applications.

In many force-based input devices, application of excessive force to the input pad or touch screen can cause significant damage to one or more components of the device, cause erratic readings and errors to occur, and even lead to breakage or permanent damage. Specifically, as forces are often concentrated to one or more specific components or areas of the force-based input device, these are particularly sensitive to excessive forces. For example, in some force-based input devices, multiple beam segments exist, which support the input panel and deflect upon a force being applied to the input pad. Such an input device is designed to concentrate the applied force across the beam segments, causing them to bend in response to the load applied to the input panel. The resulting bending stresses and strains in the beam segments are measured and processed to obtain or derive specific characteristics about or related to the applied force, such as its location and/or magnitude as it relates to the input device. If the applied force to the input device is excessive, however, the resulting bending stresses experienced by the individual beam segments can exceed the material limits of the beams, causing permanent plastic deformation which can affect or prevent future functionality.

### SUMMARY OF THE INVENTION

In light of the problems and deficiencies inherent in the prior art, the present invention seeks to overcome these by providing a system for preventing damage to a force-based input device caused by the application of excessive force. The system can include a force-based input device having an input panel supported by a plurality of beam segments, with each of the beam segments having one end fixed relative to a base frame or chassis and the other movable end coupled to or otherwise operable with the input panel. The system can further include sensing means coupled to or otherwise operable with the beam segments that emit an electrical signal proportional to the deflection of the beam segments, such as in a direction perpendicular to the plane of the input panel. The system can also include a stress-limiting device operable about the movable ends of the beam segments to limit their deflection to within a pre-determined range.

The present invention can also include a system for protecting a force-based input device having an input panel that is flexibly supported within a surrounding frame by a plurality of beam segments, with each of the beam segments further comprising a fixed end secured to the frame, a movable end coupled to or otherwise operable with the input panel, and means for providing an electrical signal proportional to the deflection of the beam segments along a translational axis perpendicular to the plane of the input panel. The protection system can include a stress-limiting device operable about the movable end of each of the beam segments to facilitate limited deflection of the beam segment within a pre-determined range, even when the force-based input device is subjected to an excessive load or impact.

In accordance with the invention as embodied and broadly described herein, the present invention also resides in a method for preventing damage to a force-based input device caused by the application of excessive force. The method includes the steps of obtaining a force-based input device comprising an input panel flexibly supported within a surrounding frame by a plurality of deflecting beam segments, and limiting the deflection of the beam segments with a stress-limiting device to a pre-determined range of motion within the elastic range of the beam segments.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 illustrates a perspective view of a force-based input device connected to a signal processing means and a computer in accordance with an embodiment of the present invention;

FIG. 2 illustrates a bottom view of a force-based input device having an input pad supported by multiple integral beam segments and provided with instrumentation or sensors for detecting or measuring stress;

FIG. 3 illustrates a perspective, close-up view of an integral beam segment provided with a stress-limiting device, according to an exemplary embodiment of the present invention;

FIG. 4 illustrates a top view of the integral beam segment and stress-limiting device of FIG. 3;

FIG. 5 illustrates a cross-sectional side view of the integral beam segment and stress-limiting device of FIG. 4 taken along section line A-A;

FIG. 6 illustrates a perspective view of a modular beam segment and support frame provided with a stress-limiting device, according to an exemplary embodiment of the present invention;

FIG. 7 illustrates another perspective view of the modular beam segment and support frame of FIG. 6;

FIG. 8 illustrates a side view of the modular beam segment and support frame of FIG. 6;

FIG. 9 illustrates a perspective view of a modular beam segment and support frame provided with a stress-limiting device, according to another exemplary embodiment of the present invention; and

FIG. 10 illustrates a perspective view of a modular beam segment and support frame provided with a stress-limiting device, according to yet another exemplary embodiment of the present invention.

### DETAILED DESCRIPTION OF EXEMPLARY EMBODIMENTS

The following detailed description of the invention makes reference to the accompanying drawings, which form a part thereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. As such, the following more detailed description of the exemplary embodiments of the present invention is not intended to limit the scope of the invention as it is claimed, but is presented for purposes of illustration only: to describe the features and characteristics of the present invention, and to sufficiently enable one skilled in the art to practice the invention. Accordingly, the scope of the present invention is to be defined solely by the appended claims.

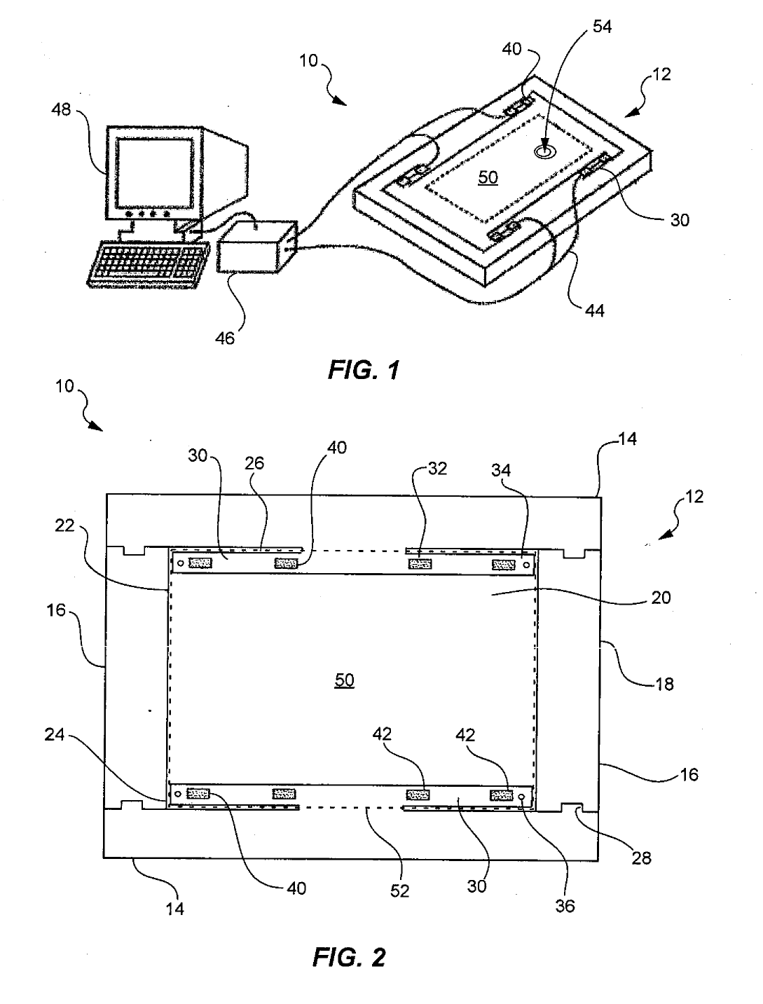

The following detailed description and various exemplary embodiments of the present invention for a Stress-Limiting Device For Forced-Based Input Panels will be best understood by reference to FIGS. 1-10, wherein the elements and features of the invention are designated by numerals throughout.

As generally described, the present invention is a system and method for preventing damage to a force-based input device, such as a touch-screen, having an input panel or pad supported by multiple displaceable and bendable beam segments. Each of the beam segments supporting the input pad can have a fixed end attached to a supporting frame or chassis, and a movable end coupled to or otherwise operable with an input pad or touch panel. The beam segments can be instrumented or equipped with sensors that detect mechanical stress/strain in the beams and output an electrical signal proportional to that strain. Pressing on the input pad can cause the applied force to be transferred through the input pad to one or more of the bendable beam segments (depending on the contact location of the applied force), which can deflect slightly and enter a state of stress in response to the applied force. The sensors in each beam segment can detect and produce an electrical signal proportional to the level of resulting strain in that segment. Properly combining the signals from all sensors in all beam segments in a processing unit allows identification of the exact magnitude and location of the touch or applied force.

Touch screens based on the deflectable beam segment design can provide significant advantages over other types of input devices. These benefits can include imperviousness to accumulations of dirt, dust, oil, moisture or other foreign material on the input pad, the ability of detecting a force applied to the input pad by any object capable of applying a force to the input pad, such as gloved fingers, bare fingers, styli, pens pencils, and the capability to measure both the magnitude and location of the applied force on the input pad or panel. Despite their advantages, force-based input devices are also susceptible to damage from excessively high forces or loads, as might be applied by a careless or malicious user. The system of the present invention can protect the touch screen from the severe damage that could result from the application of an excessive force that could otherwise bend or deflect the beam segments beyond their elastic limit and cause permanent plastic deformation and/or render the touch-screen unusable. The present invention protects against this harm by providing a stress-limiting device which acts to limit the deflection of the beam segments to within a pre-determined range of motion, which range can fall well inside the elastic limits of the beam segments or which can push the elastic limits of the beam segments. Nonetheless, it is intended that the movement or bending of the beam segment is restrained before plastic deformation can occur.

Typically, each of the beam segments supporting the touch-screen is configured with one end fixed relative to a supporting frame or chassis, and the other end movable and coupled to or otherwise operable with the input pad. In such a configuration, the stress-limiting device is operable about the moveable end of the beam segment. However, alternative beam support configurations are possible, such as a flexible beam segment supported at both ends and configured to flex in the center span with a bowing movement. It is to be appreciated that the stress-limiting device can be modified and adapted to interact with these alternative beam segment designs and still fall within the scope of the present invention.

The present invention provides several operational benefits to force-based touch screens, some of which are recited here and throughout the following more detailed description. For instance, the stress-limiting device can be configured to interact with the beam segments only in situations when an excessive load is applied, and otherwise avoid contact with the beam segment during normal operation. In other words, the stress-limited device provides substantially “transparent” protection to the touch screen, which does not incur any detrimental or secondary losses as a by-product of that protection.

As a touch screen built upon deflectable beam segments can operate in both directions along the translational axis orientated perpendicular to the plane of the input pad, the stress-limiting device can be appropriately configured to restrain excessive bending in either direction as well. This aspect of the stress-limiting device can be particularly useful in limiting not only excessive direct displacement in the direction of the applied force, but also excessive rebound displacement in the direction opposite the applied force, as permanent damage from rebound can also occur if the applied force is an impact event sufficiently severe to cause the input panel and beam segments to behave in a spring-like fashion. Additionally, the limits on the pre-determined range of motion provided by the stress-limiting device can be adjustable and configurable, both before and after the touch screen has been assembled, to allow for optimization or adjustment both during and after manufacture.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

With reference to FIGS. 1 and 2, illustrated is a force-based input device or touch screen 10 that is configurable in accordance with an exemplary embodiment of the present invention. The input device 10 can have a base frame or chassis 12 that can be an assembly of two beam support sections 14 and two side sections 16, which when assembled form a substantially rectangular base frame 12 having an outer periphery 18 and an inside edge 22 which defines the interior space or volume 20. The interior volume 20 of the frame 12 circumscribes the location for a substantially rectangular input pad 50, shown by dashed lines in FIGS. 1 and 2. The beam support sections 14 and side sections 16 can be positioned and locked together with stub joints 28 as shown, or with any other means available in the art for securely fastening the beam support sections 14 and side sections 16 together to form a rigid base frame or chassis 12.

The two beam support sections 14 can each support a pair of isolated beam segments 30 within the interior volume 20. The beam segments 30 can be integrally formed with the beam support sections 14 (as shown), or formed separately as individual beam modules and subsequently attached to the beam support sections 14 with a fastening device, adhesives, welding, etc. Although a variety of configurations are available, the beam segments 30 are typically configured with one end 32 fixed relative to the supporting frame or chassis 12, and the other end 34 movable and coupled to or otherwise operable with the input pad 50. In the embodiment shown, the ends 34 are coupled to the input pad 50 using any known fastening or attachment means, such as bolts, screws, etc. The fixed ends 32 of the beam segments 30 can be attached near the mid-span of the beam support sections 14, with the movable ends 34 arranged near the corners 24 of the interior volume 20. Locating the movable ends 34 towards the corners 24 of the interior volume 20 maximizes the movement of the input pad 50 in response to any particular applied force (shown as applied force 54) and boosts the sensitivity of the input device 10. The beam segments may also comprise varying widths or thicknesses, such as one or more narrow portions proximate the sensors, to also increase sensitivity of the input device.

The beam segments 30 can further be configured with instrumentation or sensors 40 that determine the deflection of the isolated beam segments, either directly or indirectly, through measurement of any property related to displacement of the isolated beam segments 30. For instance, the sensors 40 can comprise strain gauges 42 for measuring the bending-induced stress in the beams, piezoelectric sensors for directly measuring the curvature of the surface of the beam, eddy-current proximity probes for measuring the motion of the movable end 34, as well as capacitance gauges, liquid level gauges, laser level gauges, or any suitable gauge. The sensors 40 can generate an electrical signal corresponding to the displacement of the isolated beam segments 30, and transmit the electrical signal via a transmission means 44 to processing means capable of determining a location and/or magnitude of the applied force.

In the configuration for the force-based input device illustrated in FIGS. 1 and 2, two strain gauges 42 can be attached to each beam segment, which strain gauges are strategically located about the beam segments in a differential configuration, with one gauge proximate the fixed end 32 of the beam and the other proximate the moveable end 34 of the beam. Installing two strain gauges 42 on each beam segment and wiring them correctly can produce beneficial effects, such as self-cancellation of lateral or non-translational axis force components and noise or temperature induced-drifting effects, and additive summation of force components aligned with the translational axis.

Although a common configuration can include two strain gauges 42 or sensors 40 on each beam segment 30, it is understood that one, two or more than two sensors 40 may be disposed along each isolated beam depending upon system constraints and other factors. In addition, it is contemplated that the sensors 40 may be comprised of the beam segments 30 themselves, if appropriately configured and formed of an appropriate material. For instance, each beam segment 30 may be configured as a composite structure comprising a layer of piezoelectric material sandwiched between upper and lower electrodes, which composite structure can simultaneously support the input pad 50 and generate an electrical signal proportional to the bending and flexing of the beam segment.

Also illustrated in FIG. 2, which is a bottom view of the force-based input device 10, is an aperture or gap 26 between each beam segment 30 and the beam support section 14. With beam segments integrally formed with the beam support section 14, the aperture 26 can be cut into the beam support section 14 to form the beam segment 30. In other configurations, such as with modular beam segments, the gap 26 can be formed when a beam segment, having a center section narrower than the width of the fixed end 32, is coupled to the frame 12.

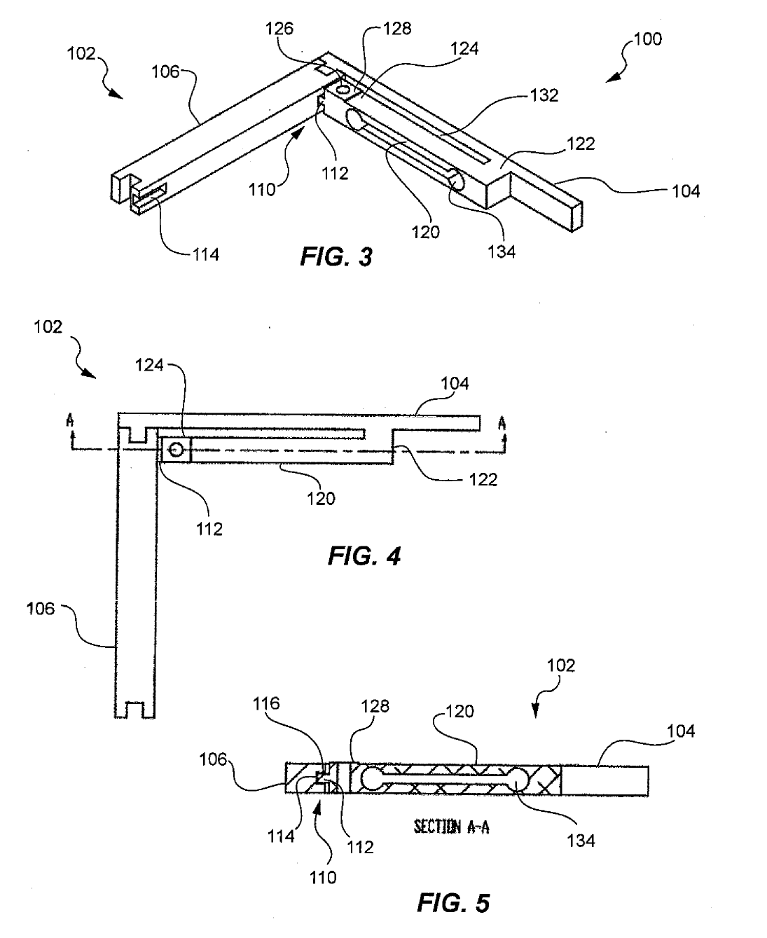

The input pad 50 can be attached to the movable ends 34 of each the beam segments 30 with a suitable fastener, such as a bolt, or similar device inserted into attachment holes 36 formed in the movable ends. Other means for attachment, such as rivets, adhesives, welding, etc., can also be considered. Furthermore, a top portion (not shown, but see FIG. 3) of the movable end of the beam segment, adjacent the attachment hole 36, can be raised above the rest of the beam segment 30 to elevate the input pad 50 and provide a clearance space between the beam segments and the input pad positioned directly overhead. The input pad can be sized with an outer perimeter 52 which fits inside the interior edge 22 the interior volume 20, to allow free motion of the input pad 50 within and about the interior volume 20 as the beam segments deflect in response to the applied forces.

Both the base frame 12 and the input pad 50 can be formed of any suitably inelastic materials that can support and transfer, or transmit the applied force 54. The materials can be a metal, like aluminum or steel, or can be a suitably inelastic, hardened polymer material, or even may be glass, ceramics, and other similar materials that can allow the transmission of an optical image simultaneous with the measurement of the touch input, if so desired. The base frame 12 and input pad 50 can be made from the same or different materials.

Both the base frame 12 and input pad 50 can be shaped and configured to fit within any type of suitable interface application. For example, the base frame 12 or chassis can be configured as surrounding the viewing area of a display monitor, which is generally rectangular in shape. In addition, the base frame 12 can be configured to be relatively thin so that the touch surface of the input pad 50 attached to the base frame 12 is only minimally offset from the viewing area of the display monitor, thereby minimizing distortion due to distance between the input pad and the display monitor.

The transmission means 44 shown in FIG. 1 can be configured to carry the sensor 40 output signals to one or more signal processing devices 46 which functions to process the signals in one or more ways for one or more purposes, such as to determine the location and/or magnitude of the applied forces on the input pad. For example, the signal processing device 46 may comprise analog signal processors, such as amplifiers, filters, and analog-to-digital converters. In addition, the signal processing devices may comprise a micro-computer processor that feeds the processed signal to a computer 48, as shown in FIG. 1. Or, the signal processing device 46 may comprise the computer 48, itself. Still further, any combination of these and other types of signal processing devices may be incorporated and utilized.

One or more signal processing devices 46 may be employed. Furthermore, processing means and methods employed by the signal processing devices 46 for processing the signal for one or more purposes, such as to determine the coordinates of the applied force, may also be employed.

Additional aspects and features of force-based input devices 10, or touch-screens, supported by multiple beam segments, and to which the stress-limiting device of the present invention can be applied, can be found in commonly owned and co-pending U.S. patent application Ser. No. 11/402,694, filed Apr. 11, 2006, and entitled “Force-Based Input Device;” U.S. patent application Ser. No. 12/002,334, filed Dec. 14, 2007, and entitled, “Force-Based Input Device Having a Modular Sensing Component,” each of which are incorporated by reference in their entirety herein. The reference application further discloses additional configurations or embodiments of force-based input devices 10 which can be used with embodiments of the present invention. Other touch screen configurations, as will occur to one of skill in the art having possession of this disclosure, can also be considered.

Illustrated in FIGS. 3-5 are perspective, top and sectional views of an integral beam segment 120 provided with a stress-limiting device 110, according to an exemplary embodiment of a force-based input device 100 of the present invention, only part of which is shown. The beam segment 120 can be integrally formed with the beam support section 104 of the base frame 102, with the fixed end 122 of the beam segment continuous with the beam support section 104 and the movable end 124 separated from the support section 104 by an aperture or gap 132. The beam segment can be configured with internal stress-concentration structures 134 which can act to focus or amplify the bending stress experienced by the beam segment 120 in regions adjacent the sensors (not shown) to increase sensitivity.

As illustrated in the drawings, the movable end 124 of the beam segment 120 can be provided with a raised contact surface 128 for elevating the input pad or panel and providing a clearance space between the beam segment 120 and the input pad (not shown) positioned directly above or below, depending upon the orientation of the device. An attachment hole 126 for accommodating a fastener or similar attachment device can be formed into the movable end 124 as well.

Also formed into the movable end 124 of the beam segment 120 can be the tongue or projecting portion 112 of the stress-limiting device 110 of the present invention. The projecting portion 112 can be configured to fit within a corresponding groove or receiving portion 114 of the stress-limiting device 110 that is formed in the adjacent side section 106 of the base frame 102. The tongue 112 can be positioned inside the groove 114 with substantial clearances 116 between both the top and bottom surfaces of the tongue and the interior surfaces of the groove, so that the tongue 112 moves freely within the groove 114 during normal operation of the input device or touch screen as the beam segment 120 deflects upwards or downwards in response to the forces applied to the input panel. The clearances 116 can be sized, however, so that the outer surfaces of the tongue 112 contact the inner surfaces of the groove 114 in the event that an excessive force or impact causes the beam segment 120 to displace or deflect to a degree that approaches its elastic limit. This contact between the surfaces of the tongue 112 and groove 114 can prevent further movement of the beam segment 120 which could prove harmful or damaging to the input device.

It can be appreciated that if the applied force is strong and excessive enough to cause the beam segment 120 to bend harmfully in one direction, the stored energy in the beam and input pad can also cause an equally severe deflection in the opposite direction during a rebound portion of the cycle. If the stress-limiting device 110 of the present invention were to be operable only in one direction, such as the direction of the normally-applied contact force, the touch screen could still incur significant damage if the beam segment 120 were allowed to exceed its elastic limits during the rebound movement in the opposite direction. To protect against this event, the tongue 112 can be completely surrounded by the groove 114, and with only enough clearance 116 on both sides of the tongue to allow the beam segment 120 to move with its elastic ranges.

In the exemplary embodiment 100 illustrated in FIGS. 3-5, the groove portion 114 of the stress-limiting device 110 can be formed into the side section 106 of the base frame 102. The side sections 106 can interconnect and attach with the beam support section 104 to form the complete and rigid frame 102 which provides the support for the force-based input device. As can be appreciated, the side sections 106 with limiting grooves 114 can be formed separately from the beam support sections 104 having integrally formed beam segments 120, including the tongue portions 112 of the stress-limiting device 110. The separate pieces can then be assembled together to form the complete system.

It is understood that similar embodiments can be considered to fall within the scope of the present invention. For instance, in an alternative embodiment the structures of the stress-limiting device could be reversed, with the tongue portion formed into the side section and the groove portion formed into the beam segment, while still providing equivalent functionality.

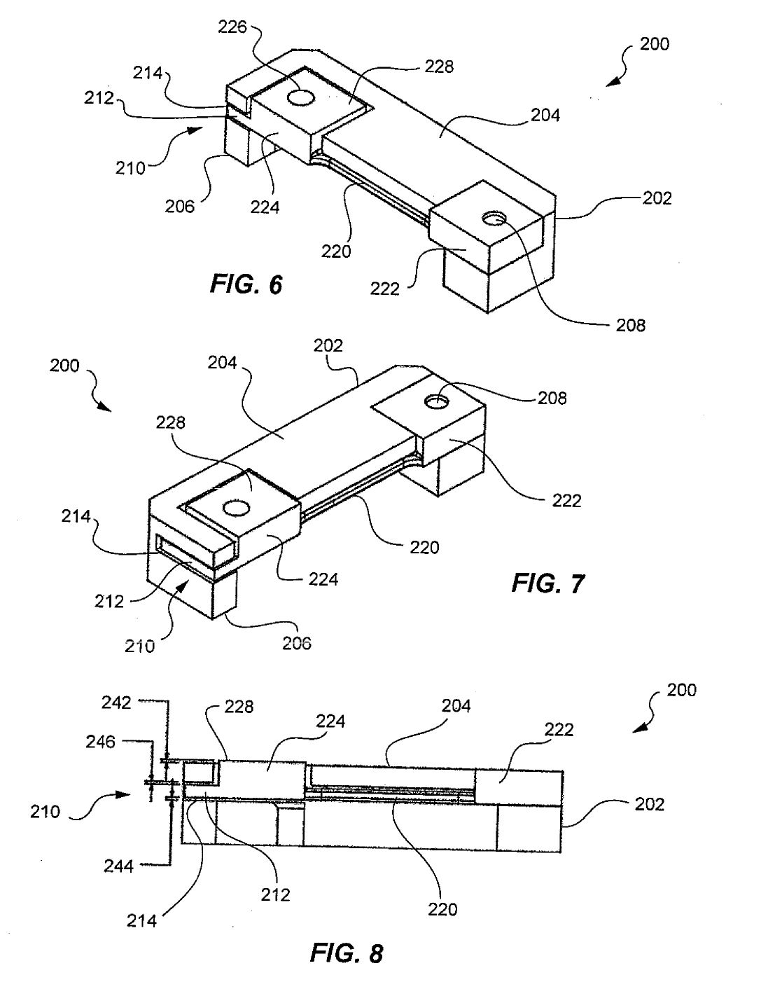

Illustrated in FIGS. 6-8 is another exemplary embodiment of a force-based input device 200 of the present invention in which a modular beam segment 220 and support frame 202 is equipped with stress-limiting device 210. The modular beam segment 220 and support frame 202 are each similar to previous configurations of force-based input devices or touch screens, as described hereinabove, with the exception that the deflecting modular beam segment 220 is separately formed and attached to a beam segment frame 204, which is also formed separate from the rigid base frame (not shown) surrounding the touch screen. Multiple modular beam and support frames 202 can be coupled to the base frame, followed by the attachment of the input panel to the beam segments 220 to complete the assembly of the force-based input device.

As further shown in the FIGS. 6-8, the deflecting beam segment 220 can have a fixed end 222 which attaches to the beam segment frame 204 by means of a fastener 208 or other similar attachment device. The beam segment 220 can also have a movable end 224 having a top surface 228 raised above the level of the beam segment frame 204 by a defmed distance 242. The top surface 228 can provide the contact surface for connection with the input panel (not shown) via a fastener or similar attachment device mounted into attachment hole 226.

Projecting further out of the movable end 224 of the beam segment 220 can be the tongue or projecting portion 212 of an exemplary embodiment of the stress-limiting device 210 of the present invention. The projecting portion 212 can be configured to fit within a corresponding groove or receiving portion 214 of the stress-limiting device 210 that is formed in an adjacent side section 206 of the beam segment frame 204 that can wrap around the movable end 224 of the beam. The tongue 212 can be located inside the groove 214 with substantial clearances 244, 246 between both the bottom and top surfaces of the tongue and the interior surfaces of the groove, so that the tongue 212 moves freely within the groove 214 during normal operation of the input device or touch screen as the beam segment 220 deflects upwards or downwards in response to the forces applied to the input panel. The clearances 244, 246 can be sized, however, so that the outer surfaces of the tongue 212 contact the inner surfaces of the groove 214 in the event that an excessive force or impact causes the beam segment 220 to displace or deflect to a degree that approaches its elastic limit. This contact between the surfaces of the tongue 212 and groove 214 can prevent further movement of the beam segment 220 which could prove harmful or damaging to the input device.

The bottom clearance 244 and top clearance 246 between the tongue portion 212 and the groove portion 214 need not be equal or symmetrical, and the stress-limiting device 210 can be configured with tighter clearances on one side than the other.

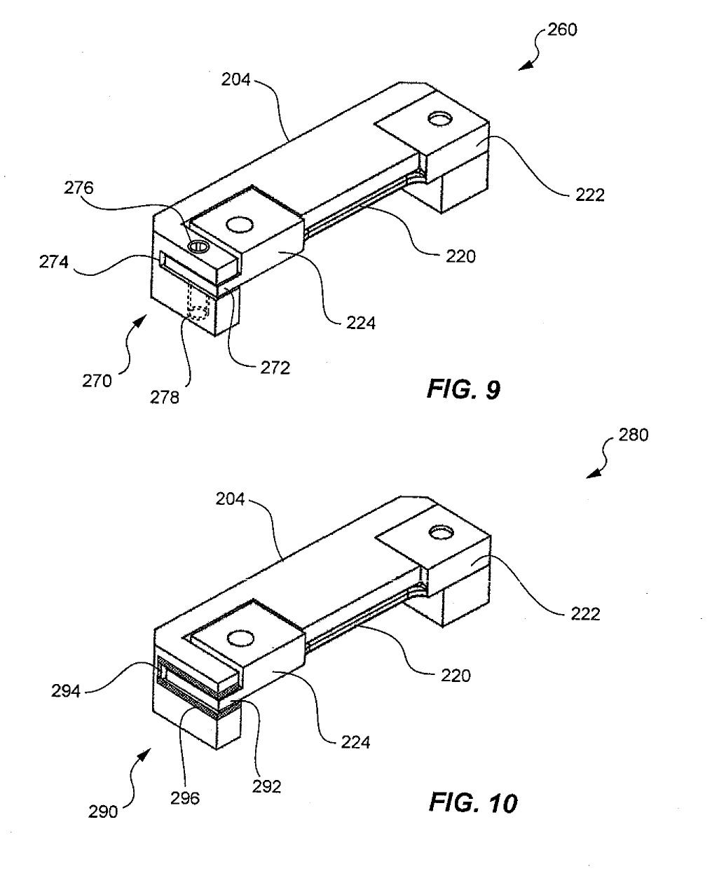

Moreover, in another embodiment 260 illustrated in FIG. 9, wherein modular beam segment 220, having a fixed end 222 and a movable end 224, is separately formed and attached to sensor beam frame 204, the clearances of the stress-limiting device 270 may be individually adjustable with set screws 276, 278 or similar devices that can function to increase or decreases the clearances between the tongue portion 272 and the groove portion 274 of the present invention.

In yet another embodiment 280 of the present invention illustrated in FIG. 10, wherein modular beam segment 220, having a fixed end 222 and a movable end 224, is separately formed and attached to sensor beam frame 204, the groove portion 294 of the stress-limiting device 290 can be configured with a conformable insert 296 made from a variety of materials. For example, the conformable insert 296 can be made from an elastomeric or energy-absorbing material which can act to soften the contact and absorb a portion of the energy passing between the tongue 292 and the groove 294 in circumstances when an excessive force or impact is applied to the input pad or panel. Absorbing a portion of the energy transmitted from the excessive applied force or impact can dampen the response of the force-based input device to the applied force, and further limit or reduce damaging rebound motion.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A system for preventing damage to a force-based input device caused by the application of excessive force, comprising:
a force-based input device comprising an input panel supported by a plurality of beam segments, each of the plurality of beam segments having an end fixed relative to a chassis and a movable end coupled to the input panel;
sensing means that emit an electrical signal proportional to a deflection of the plurality of beam segments along a translational axis substantially perpendicular to the plane of the input panel; and
a stress-limiting device operable about the movable end of each of the plurality of beam segments to facilitate limited deflection of the beam segment within a pre-determined range.

2. The system of claim 1, wherein the stress-limiting device is configured to limit deflection of the moveable end of the beam segment in either direction along the translational axis.

3. The system of claim 1, wherein the stress-limiting device is configured to limit deflection of the moveable end of the beam segment in both directions along the translational axis.

4. The system of claim 3, wherein the stress-limiting device is configured to limit deflection in both directions non-symmetrically.

5. The system of claim 3, wherein the stress-limiting device further comprises a tongue and groove configuration.

6. The system of claim 5, wherein the beam segment is configured with a tongue portion of the stress-limiting device and the chassis is configured with a groove portion of the stress-limiting device.

7. The system of claim 1, wherein the stress-limiting device is adjustable to allow changes in the pre-determined range of deflection of the beam segments.

8. The system of claim 7, wherein the pre-determined range is adjustable with a set screw.

9. The system of claim 7, wherein the pre-determined range is adjustable with an insert.

10. The system of claim 1, wherein the stress-limiting device further comprises an energy-absorbent material to dampen out rebound resulting from the application of excessive force.

11. A system for preventing damage to a force-based input device caused by the application of excessive force, comprising
a force-based input device comprising an input panel flexibly supported within a surrounding frame by a plurality of beam segments, each of the plurality of beam segments further comprising:
a fixed end secured to the frame;
a movable end coupled to the input panel; and
a means for providing an electrical signal proportional to a deflection of the beam segments along a translational axis substantially perpendicular to the plane of the input panel; and
a stress-limiting device operable about the movable end of each of the plurality of beam segments to facilitate limited deflection of the beam segment within a pre-determined range.

12. The system of claim 11, wherein the stress-limiting device is configured to limit deflection of the moveable end of the beam segment in both directions along the translational axis.

13. The system of claim 12, wherein the stress-limiting device is configured to limit deflection in both directions non-symmetrically.

14. The system of claim 12, wherein the stress-limiting device further comprises a tongue and groove configuration.

15. The system of claim 14, wherein the beam segment is configured with a tongue portion of the stress-limiting device and the frame is configured with a groove portion of the stress-limiting device.

16. The system of claim 11, wherein the stress-limiting device is adjustable to allow changes in the pre-determined range of deflection of the beam segment.

17. The system of claim 11, wherein the stress-limiting device further comprises an energy-absorbent material to dampen out rebound resulting from the application of excessive force.

18. A method for preventing damage to a force-based input device caused by the application of excessive force, comprising:
obtaining a force-based input device comprising an input panel flexibly supported within a surrounding frame by a plurality of deflecting beam segments, each of the plurality of beam segments further comprising:
a fixed end secured to the frame;
a movable end coupled to the input panel; and
a means for providing an electrical signal in response to a deflection of the beam segment along a translational axis substantially perpendicular to the plane of the input panel;
limiting the deflection of the beam segment with a stress-limiting device to a pre-determined range of motion within the elastic range of the beam segment.

19. The method of claim 18, wherein limiting the deflection of the beam segment further comprises limiting the range of motion in both directions along the translational axis.

20. The method of claim 18, further comprising adjusting the stress-limiting device to change the pre-determined range of motion of the beam segment.
